(19) United States
(12) Patent Application Publication
(10) Pub. No.: US 2016/0019698 A1
(43) Pub. Date: Jan. 21, 2016

(54) SYSTEMS AND METHODS FOR PEOPLE COUNTING IN SEQUENTIAL IMAGES

(71) Applicant: Florida Atlantic University, Boca Raton, FL (US)

(72) Inventors: Hari KALVA, Delray Beach, FL (US); Antonio Eliseo ESCUDERO HUEDO, Albacete (ES)

(21) Appl. No.: 14/804,712

(22) Filed: Jul. 21, 2015

Related U.S. Application Data
(60) Provisional application No. 62/027,009, filed on Jul. 21, 2014.

(51) Int. Cl. G06T 7/00; G06K 9/32; G06T 7/20; G06K 9/00

(52) U.S. Cl. CPC G06T 7/0042; G06K 9/00778; G06K 9/3241; G06T 7/0081; G06T 7/20; G06T 2207/10016; G06T 2207/20144; G06T 2207/30196; G06T 2207/30242

(57) ABSTRACT

Methods for counting persons in images and system therefrom are provided. The method can include obtaining image data for multiple sequential images of a physical area acquired by a camera. The method can also include, based on the image data, generating a background mask for at least one image from the multiple images, where the background mask indicating pixels identified as corresponding to non-moving regions and pixels identified as corresponding to moving regions in the at least one image meeting an exclusion criteria. The method additionally includes, based on the background mask, generating a foreground mask for the at least one image identifying pixels in the image associated with persons and computing an estimate of a number of persons in the physical area based at least on the number of the foreground pixels and pre-defined relationship between a number of pixels and a number of persons for the camera.

### CROSS-REFERENCE TO RELATED APPLICATIONS

This application claims priority to and the benefit of U.S. Provisional Patent Application No. 62/027,099, entitled “SYSTEM AND METHOD FOR ESTIMATING CROWD COUNT IN VIDEO” and filed Jul. 21, 2014, the contents of which are herein incorporated by reference in their entirety.

### FIELD OF THE INVENTION

The present invention relates to image analysis, and more specifically to apparatus and methods for people counting and density estimation at a location based on analysis of sequential images from the location.

### BACKGROUND

Many thousands of outdoor and indoor public cameras are currently available and connected to the Internet. Due to their widespread use, location, and up-to-date imagery, these webcams can be a useful resource for different studies or public services. They are placed there by governments, private citizens, public and private companies, societies, national parks and universities providing scenes that can be used for many applications, such as showing traffic, showing weather conditions, showing how crowded a public plaza is, or even monitoring natural phenomena, such as wildlife habitats in the wild or a zoo.

However, prior to using a camera for a given application, two important features have to be known; frame rate and resolution. Cameras that do not have more than four frames per seconds are considered cameras with static images. On the other hand, cameras that have over four frames per second are considered real time video cameras. Real time video cameras, which have good resolution, are used for segmentation, tracking and monitoring human being, cars or objects using different algorithms.

The most common algorithms that use real time videos use object detection by dividing the object into different components and classifying them. Their disadvantage is that they need a good frame rate and resolution, requiring high maintenance costs due to the cameras and bandwidth.

### SUMMARY

Embodiments of the invention concern systems and methods for people counting and density estimation using sequential images from a location. In particular, the embodiments concert a fast and low complexity algorithm for video surveillance and monitoring of multiple humans that will only need real time video cameras with low frame rate and resolution.

In one embodiment, a method is provided that includes obtaining image data for multiple sequential images of a physical area acquired by a camera. The method also includes, based on the image data, generating a background mask for at least one image from the multiple images, the background mask indicating pixels from the image data for the at least one image identified as corresponding to non-moving regions in the at least one image and pixels in the at least one image identified as corresponding to moving regions in the at least one image meeting an exclusion criteria. The method further includes, based on the background mask, generating a foreground mask for the at least one image identifying pixels in the image associated with persons and computing an estimate of a number of persons in the physical area based at least on the number of the foreground pixels and pre-defined relationship between a number of pixels and a number of persons for the camera.

The method can further include determining locations of persons in the physical area based on the foreground pixels. The determining can be performed by extracting feature points in the at least one image based on the foreground mask and identifying the locations of person in the physical area based on a clustering of the feature points in the at least one image.

In the method, the exclusion criteria can include at least one of a moving shadow removal criteria, a moving vegetation removal criteria, or a moving vehicle removal criteria.

In the method, the computing of the estimate can include compensating for a perspective distortion of the at least one image by dividing the at least one image into a plurality of frames and computing a number of the foreground pixels in each of the plurality of frames and summing together the number of the foreground pixels in each of the plurality of frames, weighted by a constant for a corresponding one of the plurality of frames.

In the method, the preceding steps of the method can applied to a select portion of the at least one image.

Other embodiments can include systems and computer-readable media for implementing the method described above.

### BRIEF DESCRIPTION OF THE DRAWINGS

FIG. 1 is a schematic illustration of camera positioning in accordance with an embodiment of the invention;

FIG. 2 is a general block diagram of a system design in accordance with an embodiment of the invention;

FIG. 3 is a detailed block diagram of a system design in accordance with an embodiment of the invention;

FIG. 4 provides and overview of the method of the various embodiments;

FIGS. 5A, 5B, 5C, 5D, and 5E illustrate a process of background subtraction according to an embodiment of the invention;

FIGS. 6A, 6B, and 6C illustrate a process of background subtraction, with greenery removal, according to an embodiment of the invention;

FIG. 7 schematically illustrates the concept of a vanishing point;

FIGS. 8A and 8B illustrate frame division in accordance with an embodiment of the invention;

FIG. 9 illustrates feature point extraction in accordance with an embodiment of the invention;

FIG. 10 illustrates clustering in accordance with an embodiment of the invention;

FIG. 11 shows sample images of videos tested at first through seventh locations;

FIG. 12 shows a plot of a number of persons counted in accordance with an embodiment of the invention for the first location in FIG. 11;

FIG. 13A shows a plot of a number of persons counted in accordance with an embodiment of the invention and error percentage as a function of time for the first location in FIG. 11;

FIGS. 13B and 13C show sample images at different times for the first location in FIG. 11;

FIG. 14A shows a plot of a number of persons counted in accordance with an embodiment of the invention and error percentage as a function of time for the second location in FIG. 11;

FIGS. 14B and 14C show sample images at different times for the second location in FIG. 11;

FIG. 15A shows a plot of a number of persons counted in accordance with an embodiment of the invention and error percentage as a function of time for the third location in FIG. 11;

FIGS. 15B and 15C show sample images at different times for the third location in FIG. 11;

FIG. 16A shows a plot of a number of persons counted in accordance with an embodiment of the invention and error percentage as a function of time for the fourth location in FIG. 11;

FIGS. 16B and 16C show sample images at different times for the fourth location in FIG. 11;

FIG. 17A shows a plot of a number of persons counted in accordance with an embodiment of the invention and error percentage as a function of time for the fifth location in FIG. 11;

FIGS. 17B and 17C show sample images at different times for the fifth location in FIG. 11;

FIG. 18A shows a plot of a number of persons counted in accordance with an embodiment of the invention and error percentage as a function of time for the sixth location in FIG. 11;

FIGS. 18B and 18C show sample images at different times for the sixth location in FIG. 11;

FIG. 19A shows a plot of a number of persons counted in accordance with an embodiment of the invention and error percentage as a function of time for the seventh location in FIG. 11;

FIGS. 19B and 19C show sample images at different times for the seventh location in FIG. 11;

FIGS. 20A, 20B, 20C, 20D, and 20E show images with errors;

FIG. 21 illustrates a clustering result for two people together in accordance with an embodiment of the invention;

FIG. 22 illustrates a clustering result for a person on a bike in accordance with an embodiment of the invention; and

FIG. 23 illustrates an incorrect clustering result for two people in accordance with an embodiment of the invention.

FIG. 24A and FIG. 24B illustrate exemplary system embodiments.

### DETAILED DESCRIPTION

The present invention is described with reference to the attached figures, wherein like reference numerals are used throughout the figures to designate similar or equivalent elements. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operations are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

Many times we decide to go to a place depending on how crowded the place is or the weather conditions at that moment. Our decisions are made based on different aspects that are only known in real time, since the traffic, or the population of a place can change in a few minutes. You can often lose valuable time and money driving to realize that a shop is very crowded and it is not possible to buy what you wanted. Creating a system to obtain this information would be helpful. Keeping all this in mind and also the large number of cameras that are freely available, we should require a cost effective, approximate and efficient method to identify how crowded an area is. The problem addressed above is taken care of by creating a system that can be used to keep track of a certain outdoor or indoor area. This system can retrieve information in real time and store it in a database. Then, that information can be used by an app or a website to retrieve how crowded a place is upon user request.

The present invention addresses such issues by providing a camera-based solution that uses analysis of multiple consecutive images (whether from private or public cameras) and allows users or agencies to know how crowded a given location is at a specific time and have a record of the location over the time.

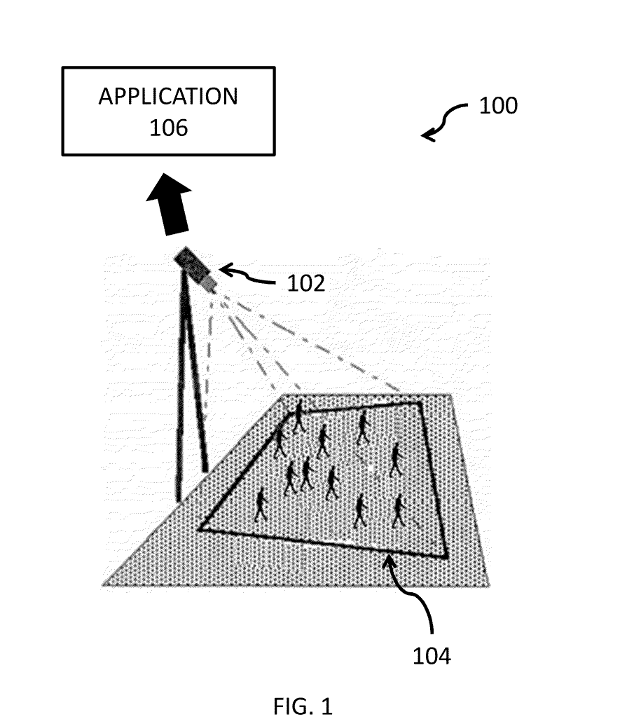

FIG. 1 shows a schematic illustration of camera positioning in accordance with an embodiment of the invention. As shown in FIG. 1, a system 100 in accordance with an embodiment of the invention will require the use of a camera 102 focusing the target location 104 as shown. The images are then provided to an application 106 or other type of image processing system for processing. The camera 102 and the application 106 can be communicatively coupled via any type of wired or wireless communication links. The application 106 can capture frames from the camera 102 in real time and will process them using the methods explained below by applying background subtraction for human counting and individual detection.

For indoor or noiseless scenes, the method of the various embodiments applies a background subtraction specifically designed for low quality videos with noise and light conditions. After that, a fast, simple and low resources model, previously trained, can be used to extract the number of people in the scene (human counting). Finally, the best feature points can be extracted using a corner detector and clustered using a k-means algorithm to preserve the high system speed (individual detection).

In some embodiments, to address outdoor scenes with a lot of noise from trees, a detection of the green parts of the frame can be provided. In particular, images can be transformed to a hue/saturation/value (HSV) color space and those green parts can be removed from the foreground in the background subtraction module. Afterwards, a model can be created and used to obtain the number of people and the best feature points will be clustered.

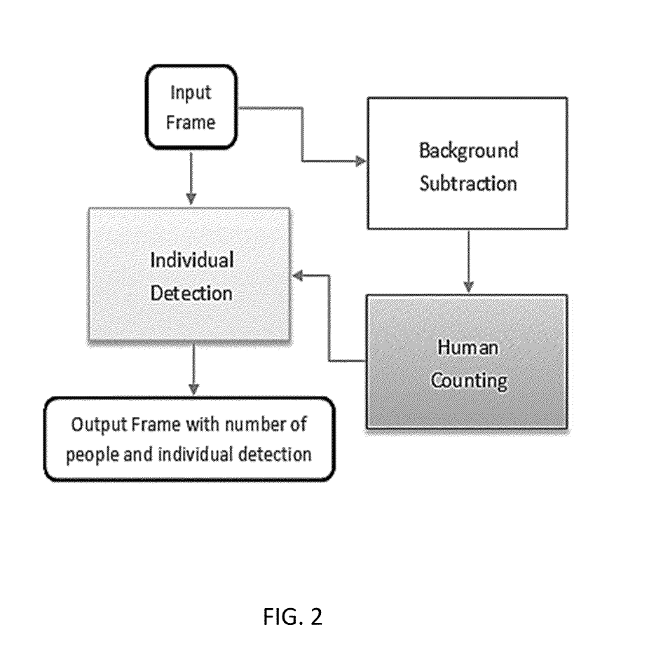

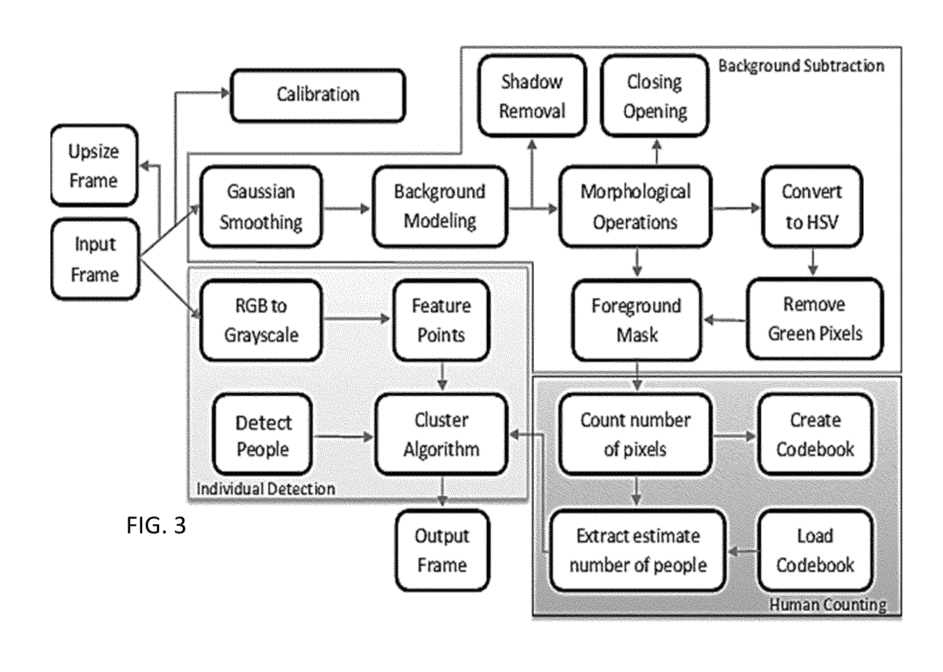

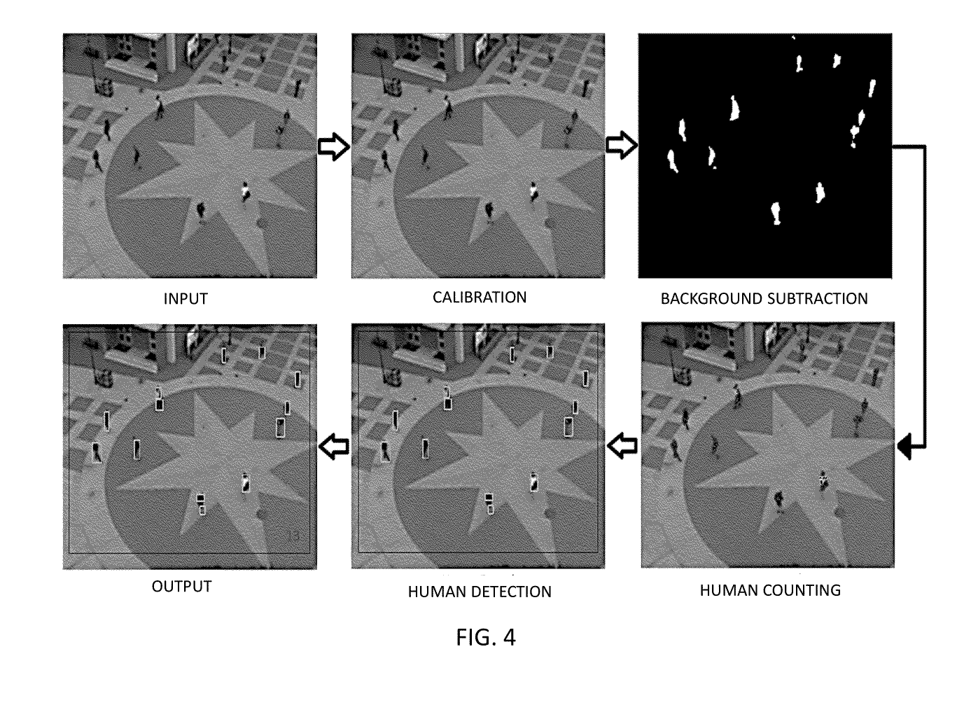

FIG. 2 is a general block diagram of a system design in accordance with an embodiment of the invention. FIG. 3 is a detailed block diagram of the system design of FIG. 2. As shown in FIGS. 2 and 3, the system design consists of 4 principal parts: (1) calibration, (2) background subtraction, (2) human counting, and (4) individual detection. Further, as shown in FIG. 3, each of these four parts can include further components or sub-parts. Details of each of these four parts are discussed below in greater detail.

Calibration

In the various embodiments, calibration primarily consists of drawing lines parallels to the edges of the frame to reduce the area where we will be counting and detecting people. This also allows counting to be limited to one or more specific regions of a frame. For example, counting can be limited to people entering and leaving a store entrance. The calibration process allows the administrator of the codebook (explained in further detail below) not to take into consideration those human's bodies that are entering or leaving the area that the frame is showing. Therefore, the codebook will be only count those bodies that are half located into the frame. Also, the image will be upsized if necessary to have a bigger resolution. This module is optional when the objective to count people in the entire frame.

Background Subtraction

In the various embodiments, the background subtraction process begins with taking the multiple input frames and first converting them to RGB and HSV. These frames can be taken from either a prerecorded video or live video. A background subtraction process is then performed to remove non-moving elements from the multiple input frames. In the various embodiments, a Mixture of Gaussian (MoG) method is used. MoG methods are used to adaptively update the background image of a scene captured by a camera. Simple methods such as averaging frames do not result in good background images. MoG methods model each pixel of an image as a weighted sum of the multiple distributions used to model the pixels. The weights can be seen as the probability that the pixel value comes from that model component. This method is discussed in C. Stauffer and W. E. L. Grimson, in “Adaptive background mixture models for real-time tracking,” in Computer Vision and Pattern Recognition, 1999. IEEE Computer Society Conference on., 1999, vol. 2, p. —252 Vol. 2. and was improved by applying an adaptive nonparametric Gaussian Mixture Model as described by P. KaewTraKulPong and R. Bowden in “An Improved Adaptive Background Mixture Model for Real-time Tracking with Shadow Detection,” in Video-Based Surveillance Systems, P. Remagnino, G. A. Jones, N. Paragios, and C. S. Regazzoni, Eds. Springer US, 2002, pp. 135-144, the contents of both of which are herein incorporated by reference in their entireties. With the right parameters, a MoG approach can achieves the best precision and recall compared to other background subtraction techniques. In order to have this approach working with very low quality videos, one can add a Gaussian filter before starting the background subtraction process. That can be done by convolving each point in the input array (i.e., the input image) with a Gaussian kernel and then summing to produce the output array. Other filters can also be used in the various embodiments.

In addition to the foregoing, a shadow removal process can be applied to an image resulting from the MoG algorithm. In some embodiments, a color model can be used to separate both chromatic and brightness components. Then a comparison can be performed to compare a non-background pixel against the current background component as explained by KaewTraKulPong and Bowden (2002). In this approach, a foreground pixel is compared against the current background pixels and a shadow exclusion criteria is applied to remove pixels for moving shadows, In particular, if the difference in both chromatic and brightness components are within some thresholds, the pixel is considered as a shadow. Then and in order to count the static people, a closing operation can be added to the image, which has the shadow pixels removed, to extract clean and amplified group of pixels (these pixels are for people who are static by assuming static people have some motion) that correspond to moving regions. Finally, blobs that are very small can be removed. The foreground mask is then formed.

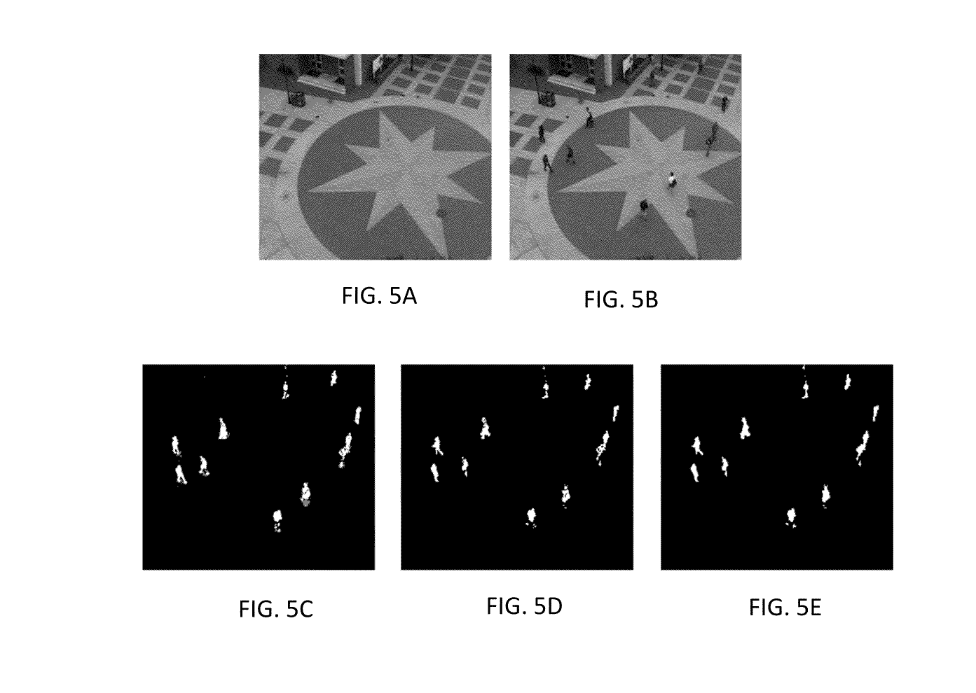

As an example, if one uses the background subtraction method described above with the images shown in FIGS. 5A and 5B, the mask after using MoG is shown in FIG. 5C. The image is typical of people counting scenarios where a camera mounted at high elevation and individuals in the image makeup a very small portion of image pixels. The mask, after shadow removal and after closing operation, is shown in FIGS. 5D and 5E, respectively.

For noise removing such as threes or bushes with motion in outdoor scenes, an additional process can be necessary in order to remove those pixels to avoid false detections. In general, as such an approach would be needed primarily in outdoor settings; this method could be avoided in indoor settings in order to save computational resources. To apply this method, the original frame is converted to HSV color space. Then, pixels associated with values of the hue element of HSV, which represents the color, between 22 and 75 are identified and used to define a moving vegetation exclusion criteria and form a mask for excluding such pixels. These cover all green pixels in HSV space. However, in other embodiments, one could convert to any other space in which values for green pixels are known such that green pixels can be identified.

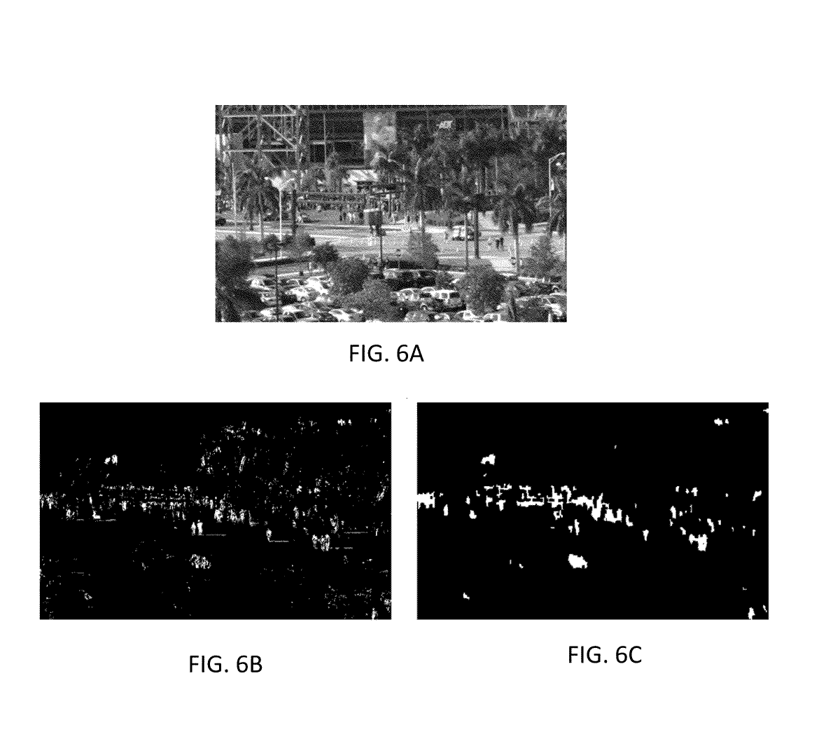

Once the mask for green pixels is formed, morphological operations are performed on the mask. Morphological operations include, but are not limited to, one or more sets of image processing operations that are used to modify shapes in images. For example, morphological operations such as erosion, dilation, opening, and closing, are applied. Such processing of the image removes unwanted noise and enhances the features of interest. Finally, this mask is used to remove those green parts contained in the background mask that was previously generated with MoG, leaving only pixels associated with persons and not greenery. FIGS. 6A-6C illustrate this process.

FIG. 6A shows the original image. This original image is a combination of foreground and background image. Fixed structures, trees, and parked cars are considered to be part of a background image and moving regions are considered to be part of the foreground image. FIG. 6B shows the the background mask generated with MoG from the image of FIG. 6A. However, such a background mask obtained from the MoG includes the moving leaves and branches from trees. FIG. 6C shows the foreground mask with the green pixels removed, as discussed above.

Human Counting

Following the background subtraction module and with the foreground mask created, a person counting is performed. In the various embodiments, a linear codebook that has been previously trained is used. A linear codebook maps foreground pixels to people count using a linear function. However, other mapping functions, including non-linear functions can also be used in the various embodiments. Thus, such a codebook should be simpler, faster and uses fewer resources. To know the estimation of people, a pixel counting algorithm is used.

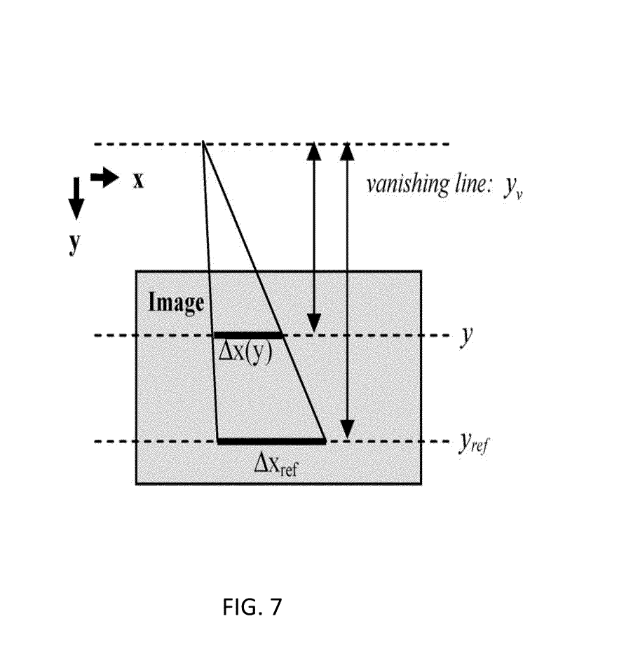

Before estimating the number of people by counting the foreground pixels, perspective distortion is taken into consideration. In some embodiments, a vanishing point method can be used where all objects at different location are brought to the same scale using a vanishing point. This is illustrated in FIG. 7. However, this method can be computationally expensive. Also, this method generally requires a vanishing point at the top of the image, which sometimes it is not possible due to the composition of the image. In particular, lines that one can extract from images do not always converge as shown in FIG. 7, rather they may get further from each other.

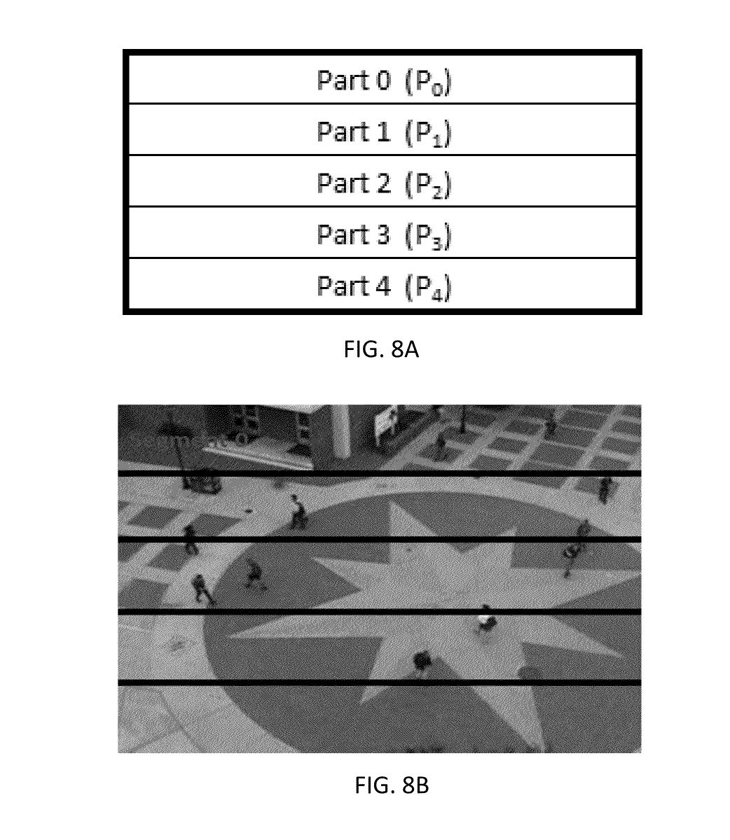

Therefore, in some embodiments, to compensate for perspective distortion without using a vanishing point, one draw X horizontal lines from the top of the frame to the bottom, as shown in FIG. 8A, leaving the frame divided into X+1 parts, as shown in FIG. 8B. The goal is to create regions with similar amounts of distortion and correct for that distortion when estimating the count. X is a parameter that can be determined by how high the camera is positioned. If the camera is not situated high enough, people at the top of the image will look smaller than the ones at the bottom and vice versa, therefore the perspective distortion method is needed. Every part in which the frame is divided will have a constant value C that will be determined by Equation 1:

$${C}_{p} = 1 - [ ( \frac{1}{X + 1} ) \times {P}_{n} ] \qquad ( 1 )$$

Then, all pixels in the foreground mask are counted for every part divided as mentioned above and multiplied by its part's constant value determined by Equation 1. Finally, every part is added to know the number of foreground pixels for human counting as shown in Equation 2.

$$Total Pixels = {\sum }_{p = 0}^{X} {C}_{p} \times pixels in P \qquad ( 2 )$$

Codebook

To determine the relationship between foreground pixels and the number of people in the frame, some manually annotated training images from a similar scene are needed. This is referred to herein as a “codebook.” This codebook can basically be a file the number of pixels and its correspondent number of people for a particular camera configuration. The total pixels computed by Equation 2 is added to a codebook along with the number of people that one can count in the scene, which sometimes is hard to do because of the quantity of people in the image. This means a codebook would have entries for the number of pixels in the frame associated with the ground truth. Using this method, a simple, fast and low resources codebook is obtained.

Obviously, this requires that the codebook be created before estimating the number of people. However, this is a training process that needs to be done only once per camera. The more training images with the ground truth from a camera, the better, since the codebook will have more results to compare for human counting. In some embodiments, a minimum of 30 training images should be used for every camera. However, any number of training images can be used.

The main advantage of this model is that for the same camera, the administrator of the camera has to train that camera only once no matter if the camera moves to some other plane or zooms in, we only need to pass the parameters (i.e. we zoomed out twice) to the model and it will automatically adjust the number of pixels extracted from the codebook. Also, due to the simplicity of the codebook, its velocity of computing is very high as well as its low use of computational resources.

Once the codebook for a given camera is created and the system wants to estimate the number of people after counting the number of pixels in the foreground mask, the codebook can be loaded. The codebook creates a variable with the pixels per person. After that, for a given frame, the estimated number of people will follow Equation 3:

$$People estimation = round ( \frac{Pixels in foreground mask}{PP} ) \qquad ( 3 )$$

Where PP is the pixels per person given by the codebook.

Individual Detection

The last step of the methodology of the various embodiments is to situate the people in the frame. People will be shown in the output frame rounded by a green rectangle.

The first step to detect people is to get only those corner-like feature points that come from humans in the image. In the various embodiments, an algorithm for good features to track can be used, as described by J. Shi and C. Tomasi, “Good features to track,” in, 1994 IEEE Computer Society Conference on Computer Vision and Pattern Recognition, 1994. Proceedings CVPR '94, 1994, pp. 593-600. 1991, the contents of which are herein incorporated by reference in their entirety. This method detects corners and identifies the strongest corners as features to track. This method is based on a feature monitoring method that can detect occlusions, dis-occlusions, and features that do not correspond to points in the world. However, any other methods for feature detection can be used in the various embodiments.

For feature point extracting, two parameters are important in order for the algorithm to work as expected. The first parameter is the number of feature points to be detected, which can be set to be large enough so that a human being shows enough evidence of his or her existence. The second parameter is the minimum distance between two feature points. Since for a human being the feature points might come from the contour or the clothing, the minimum distance can be set to 1 pixel, which in many cases is the minimum distance from head to shoulders of a person.

In order to reduce computational costs, the good features to track algorithm can be executed only where humans are situated in the frame. To do that one can simply apply the feature points algorithm in the pixels detected by the foreground mask obtained described above.

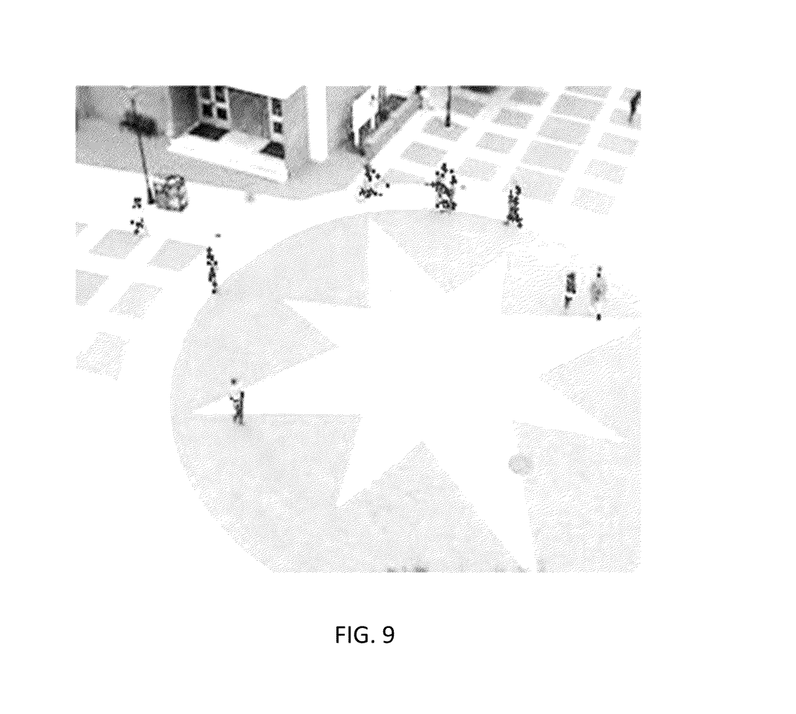

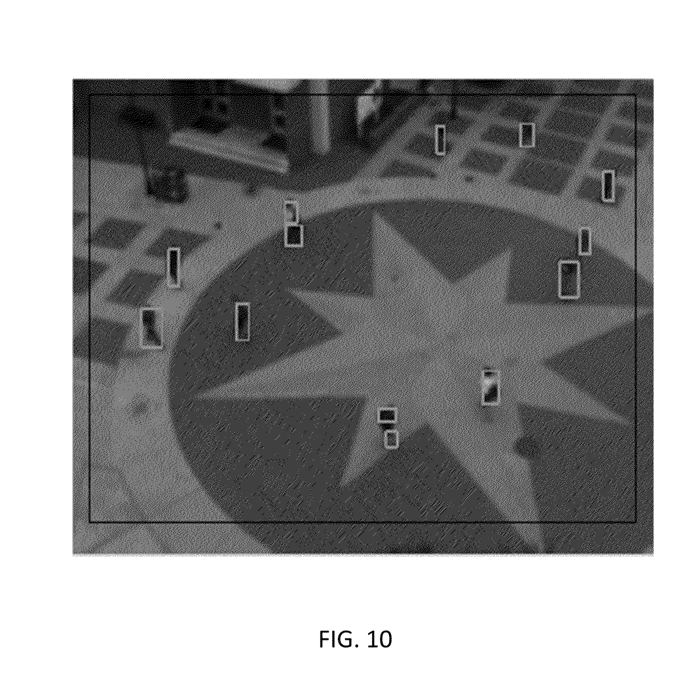

Once the feature points have been extracted as shown in FIG. 9, for example, a method to group those points is needed. In the various embodiments, a k-means clustering algorithm is used to partition n observations into k clusters, in which each observation belongs to the cluster with the nearest mean. Unlike an expectation maximization (EM) algorithm which allows cluster to have different shapes, a k-means algorithm finds clusters of comparable spatial extent. The system uses k-means rather than EM since there is no cluster model for the EM algorithm with the human shape. A difficulty in the k—means clustering algorithm is the determination of the number of clusters, but the number of people estimated by the codebook explained above. Finally, the k—means clustering algorithm can classify the feature points into its cluster number and the system will draw rectangles around them as shown in FIG. 10.

Alternative Method

The methods described above work well when there are only people in the scene. However, if cars are present, the codebook may fail since the pixels will be counted as people. Therefore, in some embodiments, a modified method is provided to solve this problem so that it will open new environments where this system can be implemented. In particular, a moving vehicle exclusion criteria can be applied to remove pixels due to moving cars. This process is explained below.

With videos that contain many people (approx. more than 50 as shown in FIG. 6A), once the foreground mask is obtained, each blob (groups of pixels that are connected) will be computed. If the histogram of the blob has many pixel for the same color (more than 70% of the blob), it can be counted as a car and can be deleted from the foreground mask. We can assume that a car has the same color over the whole shape except for the wheels and windows. After the cars are removed from the foreground mask, the human counting and human tracking algorithm will then proceed follow as explained in previous sections.

The disadvantages of this method are that it is much slower since it has to create a histogram for each blob and it will delete the people that are connected to that blob. Also, in order to have the complete car in the same blob, a high quality video may be needed, otherwise the car will be split in different blobs and the histogram will not work as expected. However, as long as the modified method is used in scenes with many people, even removing humans annexed to the car's blob should not significantly affect the estimates of numbers of people.

### Examples

The examples shown here are not intended to limit the various embodiments. Rather they are presented solely for illustrative purposes.

Dataset

Seven videos were recorded at different locations worldwide with different resolutions. The areas recorded in all of these videos are located outdoor and uncovered. They are recorded with different angles and camera's height positions. Each camera also shows an area with different weather and vegetation conditions to test the algorithm proposed with as many different environments as possible. Some of these videos were recorded with a Canon HDR-CX290/B, which gives a resolution of 1080 p with 30 fps. In order to simulate the videos as if they were recorded by a public and free camera, the videos were encoded using AVC/H.264 at a lower resolution and frame rate. All of these videos have a frame rate of 5 fps. The details of every video are shown in Table 1.

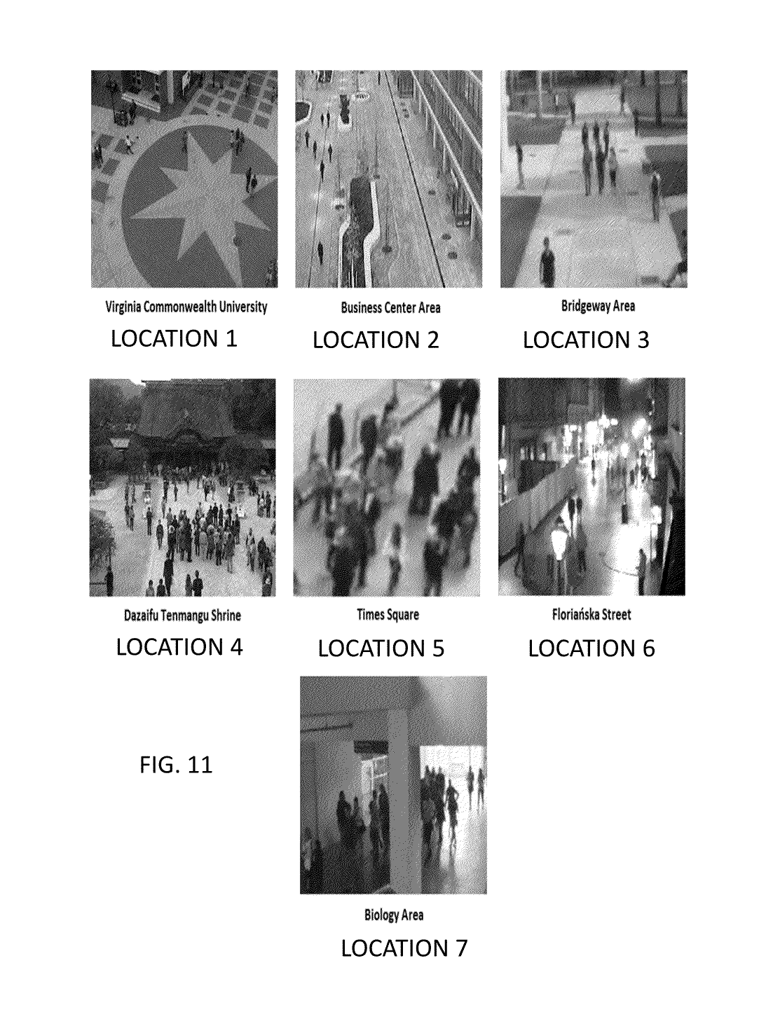

From the eight hours recorded, which contains static and moving people, weather elements, light conditions, vegetation and small elements, one can extract the weaknesses of the algorithm. Moreover, the variety of resolutions used, one can detect where we need to focus in order to make the improvements needed to use the algorithm in a wide range of places. The details for each location are listed below in Table 1. Additionally, sample images from each of these videos are shown in FIG. 11.

TABLE 1
Details for every video used

| | | | | Bitrate | |
|---|---|---|---|---|---|
| Location | City | Length | Resolution | (kb/s) | Date |
| Virginia Commonwealth | Richmond | 1:30:00 | 320 × 240 | 139 | Sep. 10, 2013 |
| University | (Virginia) | | | | |
| Business Center Area | Trondheim | 2:00:00 | 400 × 300 | 300 | Sep. 11, 2013 |
| | (Norway) | | | | |
| Breezeway Area at FAU | Boca Raton | 0:30:00 | 190 × 125 | 19 | Nov. 4, 2013 |
| | (Florida) | | | | |
| Dazaifu Tenmangu Shrine | Dazaifu | 1:00:00 | 320 × 240 | 499 | Dec. 2, 2013 |
| | (Japan) | | | | |
| Times Square | New York | 1:15:00 | 165 × 150 | 44 | Sep. 16, 2013 |
| | (New York) | | | | |
| Floriańska Street | Krakow | 1:20:00 | 400 × 300 | 175 | Sep. 17, 2013 |
| | (Poland) | | | | |
| Biology Area at FAU | Boca Raton | 0:30:00 | 250 × 180 | 57 | Nov. 4, 2013 |
| | (Florida) | | | | |

For the training of the codebook, 30 images were extracted from each video, giving a total of 210 images for the 7 videos shown above. The time between each image was equal and uniform throughout the whole video, and this time was obtained as shown in Equation 4, which gives the number of frames between every two training images. The number of people counted manually was stored with its corresponding number of pixels as explained above. In an effort to reduce the error when counting the number of people manually such that the codebook will be as accurate as possible, the ground truth was counted three times for every image, and the mean of those three was stored in the codebook.

$$NF = ( \frac{L}{NS} ) \times FR \qquad ( 4 )$$

### Where:

NF=Number of frames between every two consecutive images.

L=Length of the video in seconds.

NS=Number of samples we want to obtain (30 for training, 50 for testing).

FR=Frame rate of the video.

Experiments and Results

In order to test the performance of the algorithm for human counting, the accuracy at different time instances along the video was measured. The performance was calculated by comparing the ground truth, which is the actual number of people in the scene counted manually, with the number of people given by the algorithm. A total of 50 images for each video were used to test the algorithm, the time interval between two of them was obtained by Equation 4. Performance of the system was measured using Equation 5,

$$Performance = ( 1 - \frac{\vert ANP - PNP \vert}{ANP} ) \times 100 \qquad ( 5 )$$

### Where:

ANP=Actual Number of People

PNP=Predicted Number of People.

Taking into account the variables defined above, analogously the percentage of error was defined as shown in Equation 6:

$$Error = ( \frac{ANP - PNP}{ANP} ) \times 100 \qquad ( 6 )$$

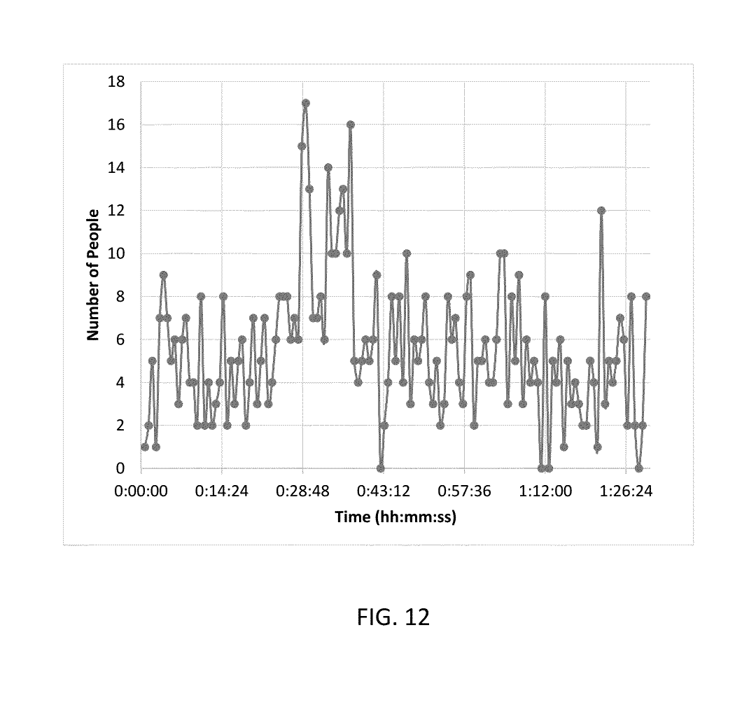

FIG. 12 shows a graphic representation of people over time for the first location (Virginia Commonwealth University). Table 2 shows the maximum and minimum number of estimated people throughout scenes for each video, the maximum miscounted people and the overall error rate in percentage, given by Equation 7, where N is the number of test images:

$$Error = \vert ( \frac{{\sum }_{i = 1}^{n} ANPi - {\sum }_{i = 1}^{n} PNPi}{{\sum }_{i = 1}^{n} ANPi} ) \times 100 \vert \qquad ( 7 )$$

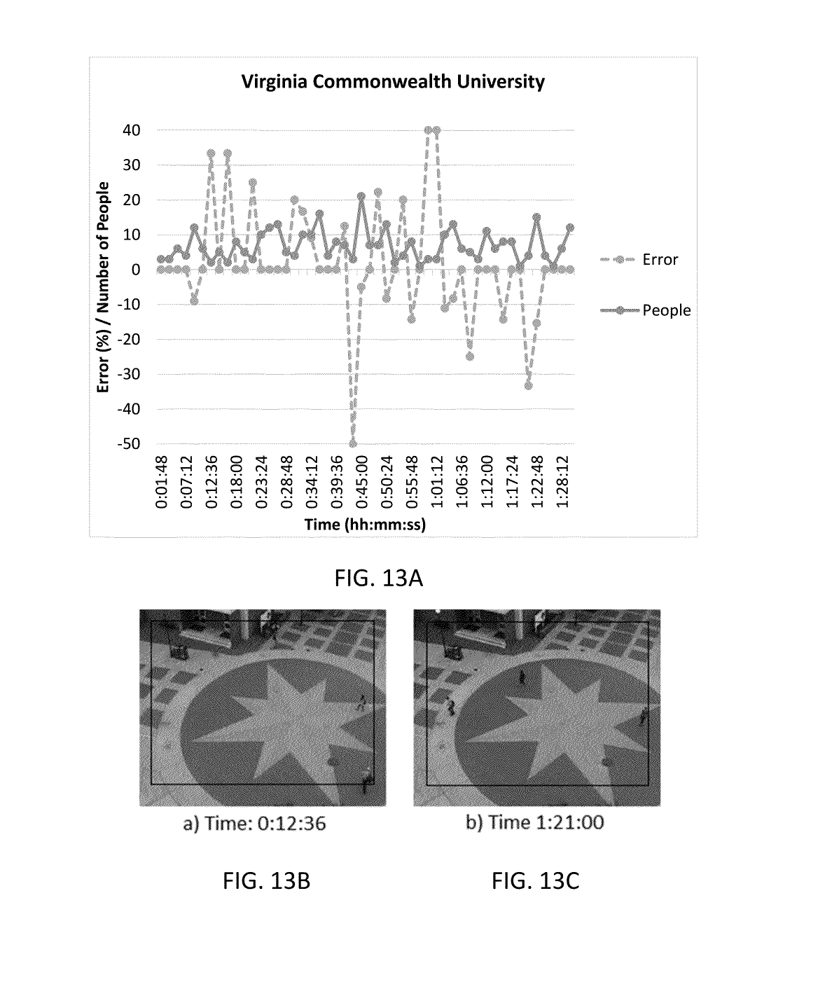

The parameters of the algorithm for each video are different depending on how high the camera is positioned, the distance from the camera to the scene, the amount of vegetation in the scene and the light conditions. FIGS. 13A, 14A, 15A, 16A, 17A, 18A, and 19A show the error for each video for the 50 test images along with its correspondent estimated number of people. Two frames of a positive and a negative error for each of these locations are also shown. A positive error in the graph means that the algorithm reports less people while negative values indicate that the algorithm reports more people.

TABLE 2
Max, min number of estimated people, max miscount
and overall error rate.

| | | | Max | Error |
|---|---|---|---|---|
| | Min | Max | miscount | rate (%) |
| Virginia Commonwealth University | 0 | 24 | 2 | 0.9 |
| Business Center Area | 0 | 12 | 1 | 0.8 |
| Breezeway Area at FAU | 0 | 25 | 3 | 2.2 |
| Dazaifu Tenmangu Shrine | 7 | 85 | 12 | 0.5 |
| Times Square | 0 | 16 | 9 | 0.3 |
| Floriańska Street | 4 | 32 | 10 | 5.0 |
| Biology Area at FAU | 0 | 21 | 2 | 8.0 |

As shown in FIG. 13A, the error rate for a first location (Virginia Commonwealth University) is 33% and −33% respectively. There are 3 people on the scene, but the algorithm reports 2 and 4 respectively. For FIG. 13B, the algorithm reports one less person since the bottom right student is not inside the frame. For FIG. 13C, the algorithm reports one person more due to the bag pack of the left student.

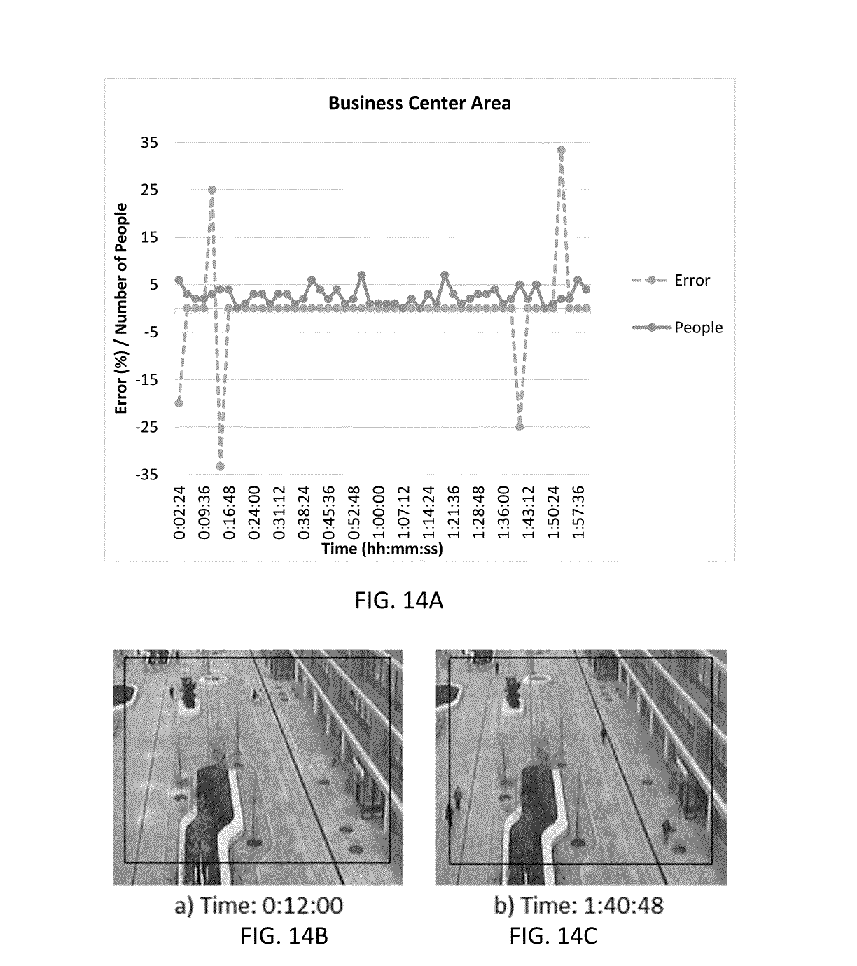

As shown in FIG. 14A, the error rate for a second location (Business Center Area) is 25% and −25% respectively. There are 4 people on the scene, but the algorithm reports 3 and 5 respectively. For FIG. 14B, the algorithm reports one less person since he is leaving the frame through the top side. For FIG. 14C, the algorithm reports one more person because the woman is almost within the frame and the rounding counts her as one more.

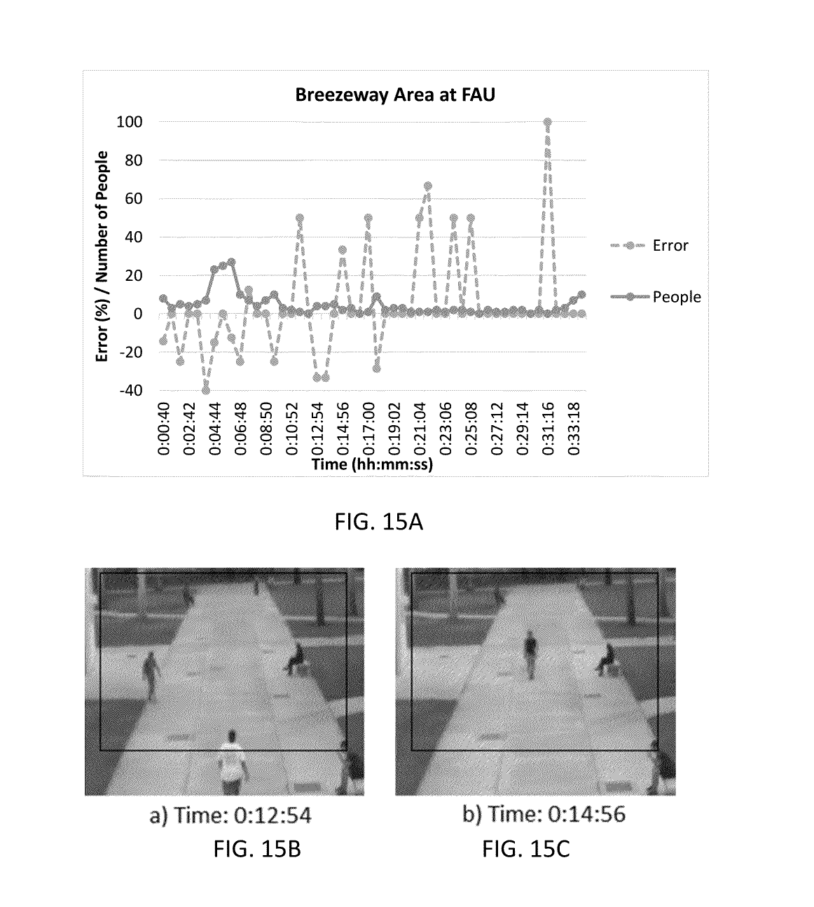

As shown in FIG. 15A, the error rate for a third location (Breezeway Area at FAU) is −33% and 33% respectively. There are 3 people on the scene, but the algorithm reports 4 and 2 respectively. For FIG. 15B, the algorithm reports one more person since there is a student coming into the scene and is counted as one more. For FIG. 15C, the algorithm reports one less person because he is seated for a long time in the top left side.

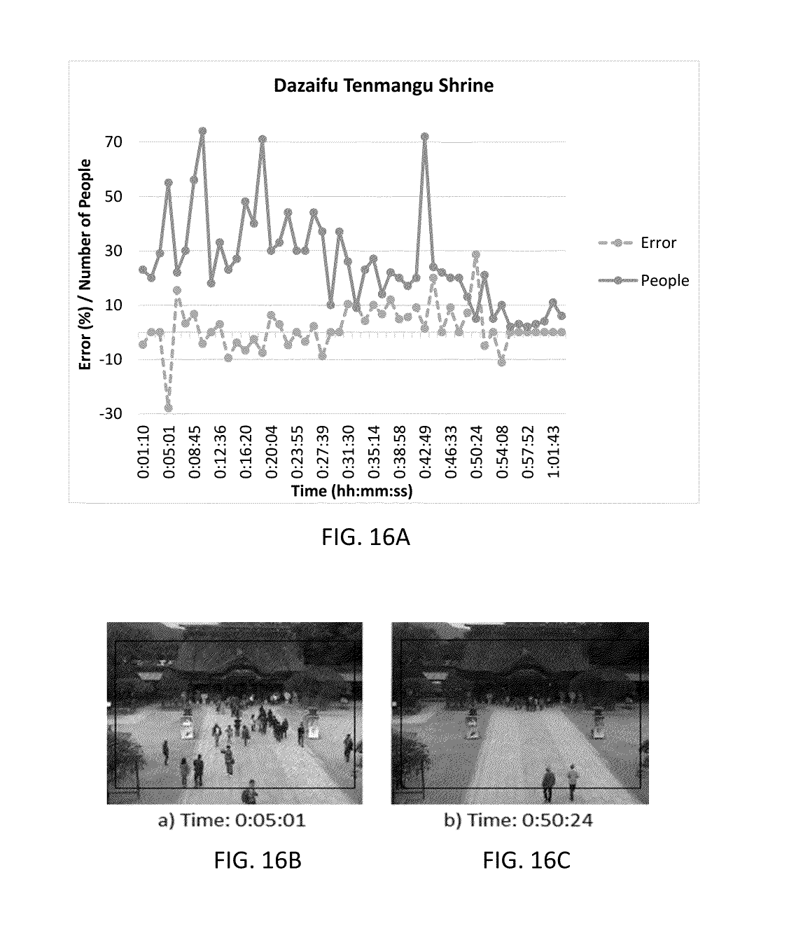

As shown in FIG. 16A, the error rate for a fourth location (Dazaifu Tenmangu Shrine) is −27% and 28.57% respectively. There are 43 and 7 people on the scene, but the algorithm reports 55 and 5 respectively. They have almost the same percentage. For FIG. 16B, the algorithm reports 12 more people. For FIG. 16C, the algorithm reports two more people. The error for FIG. 16A comes from a fast light change.

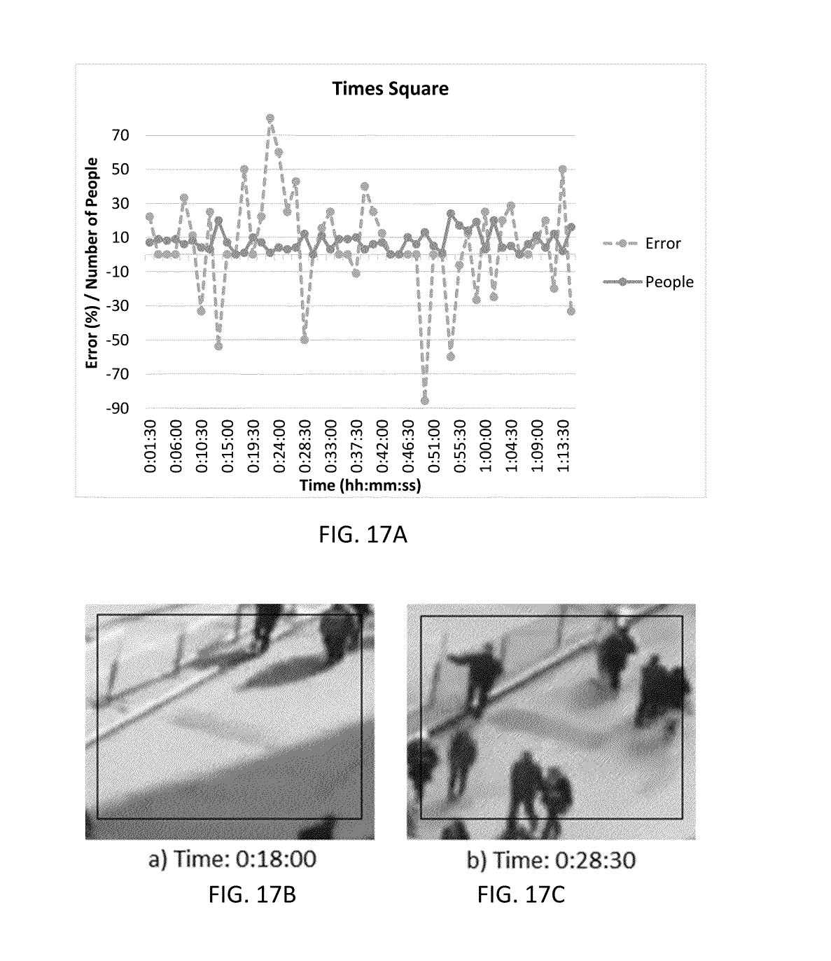

As shown in FIG. 17A, the error rate for a fifth location (Times Square) is 50% and 50% respectively. There are 2 and 8 people on the scene, but the algorithm reports 1 and 12 respectively. For FIG. 17B, the algorithm reports one less person because if you add the two parts of body, there would be as one person. For FIG. 17C, the image contains many shadows that makes the algorithm count more people.

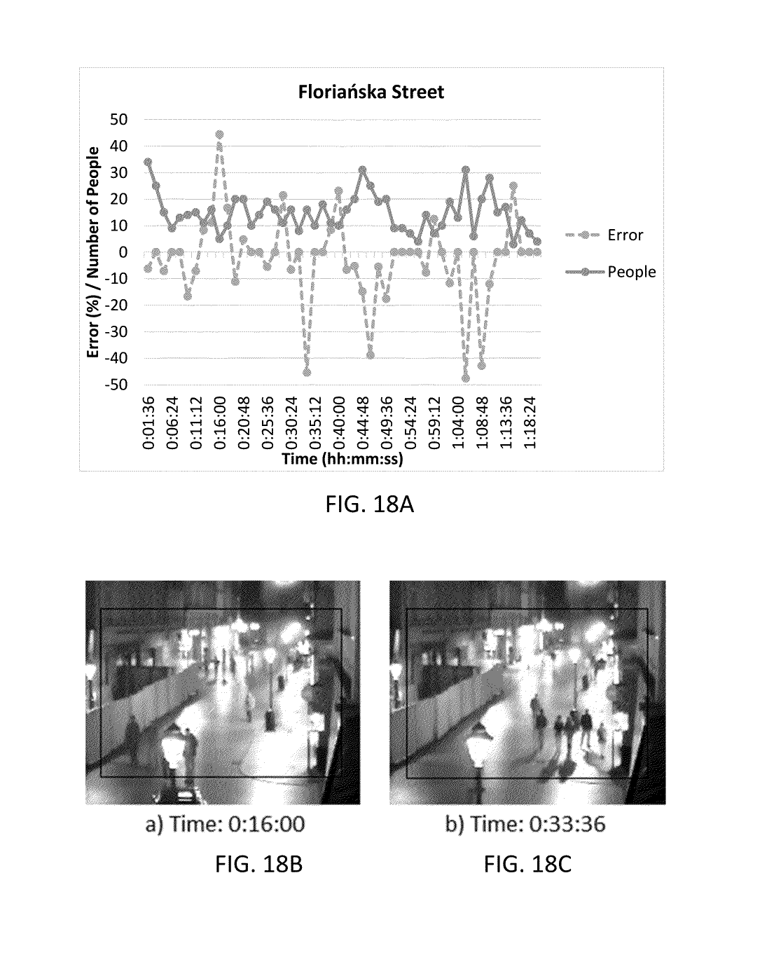

As shown in FIG. 18A, the error rate for a sixth location (Floriańska Street) is 44% and −45% respectively. There are 9 and 11 people on the scene, but the algorithm reports 5 and 16 respectively. For FIG. 18B, the algorithm reports less people because they are partially detected as shadows For FIG. 18C, the people are very well defined and the codebook gives more people than the reality.

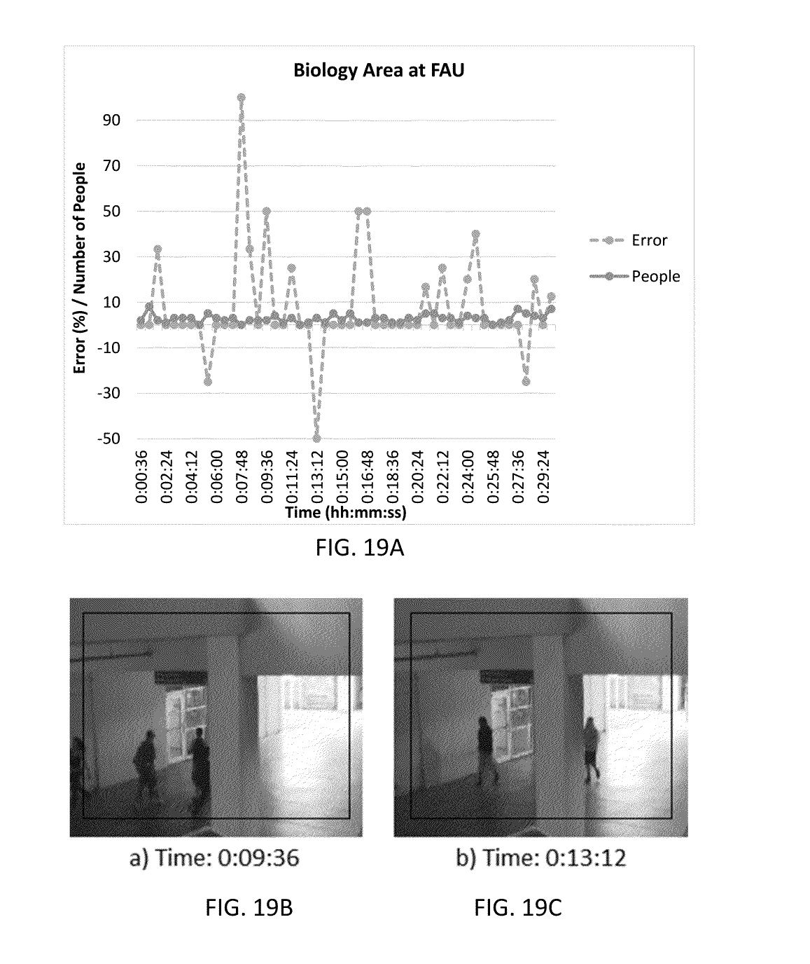

Finally, as shown in FIG. 19A, the error rate for a seventh location (Biology Area at FAU) is 50% and −50% respectively. There are 4 and 2 people on the scene, but the algorithm reports 2 and 3 respectively. For FIG. 19B, the algorithm reports less people because they are occluded. For FIG. 19C, one of the students has many pixels as body and it is counted as two.

Finally, as part of the human counting results, Table 3 shows the problems observed in the video for each one tested. Based on the results, it can be seen that the algorithm performance remains high with different environment conditions. On the other hand, it was observed that one of the most influencing factors is the video resolution as well as the bitrate. Also, the angle of the camera has a high impact in the algorithm, giving the best results those that have a camera located high enough, where the optimal solution would be to have it like a satellite. Furthermore, this algorithm gives a high error in frames where the video is frozen and have the image pixelated after recovering, such as the one in Times Square.

TABLE 3
Problems observed.

| | Problems found |
|---|---|
| Virginia Commonwealth | Bikes, dogs and luggage in the scene. |
| University | |
| Business Center Area | Birds in camera, clothes color equal to |
| | background, reflection of humans in right |
| | windows. |
| Breezeway Area at FAC | Camera not high enough, many light changes. |
| Dazaifu Tenmangu | Algorithm should be initialized when the |
| Shrine | scene is empty. |
| Times Square | Video freezes frequently, people in big |
| | costumes. |
| Floriańska Street | Bikes in the scene, light comes from many |
| | directions due to lamp posts. |
| Biology Area at FAC | Camera needs better positioning, high light |
| | from an area behind the scene. |

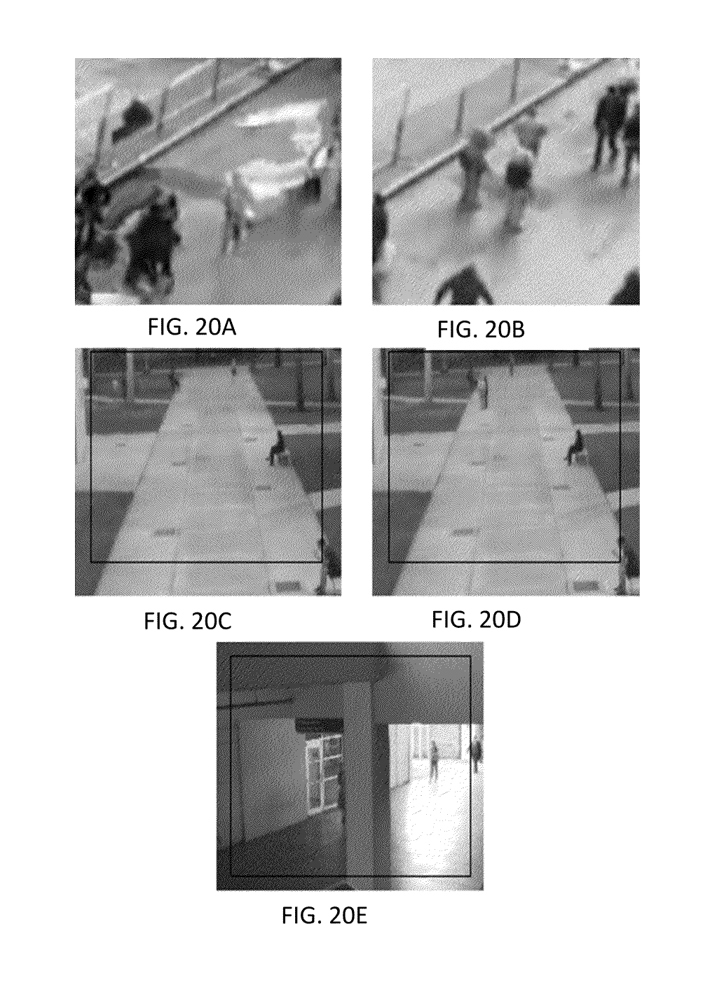

FIGS. 20A-20E shows different frames where the error is very high. FIGS. 20A and 20B show frames in the fifth location (Times Square) that give errors due to freeze image and people in big costumes respectively. FIGS. 20C and 20D show frames for the third location (Breezeway at FAU) that give errors due to people remaining static for long time. Finally, FIG. 20E shows a frame for the seventh location (Biology Area at FAU) where, due to the light coming from behind the scene, that person is not counted since her clothes have same color than the background. Also, the error in all these cases is high because there are a very few people in the scene, since if the scene has one person and the algorithm gives no one, the error will be 100%.

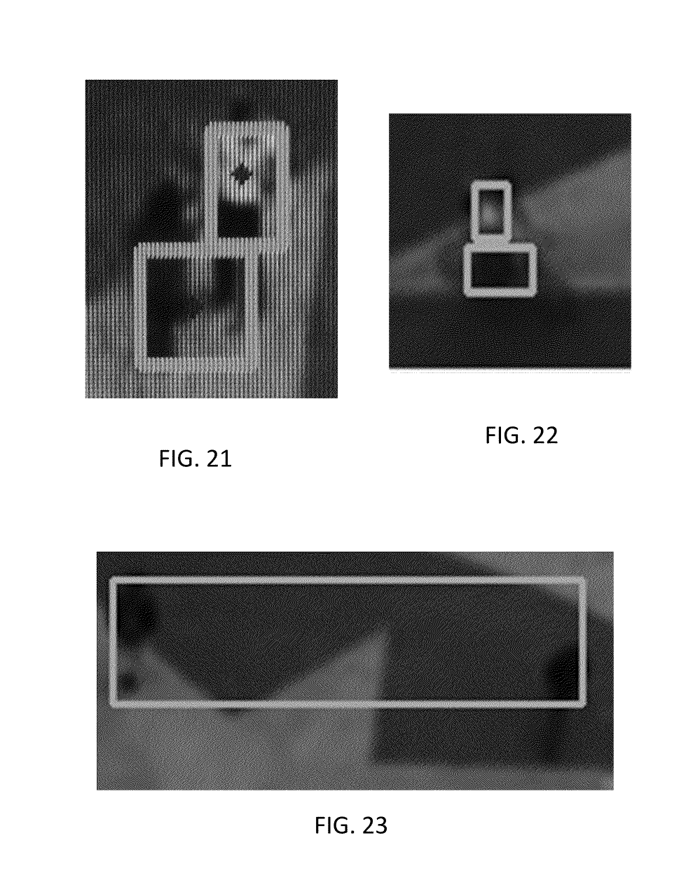

For the human detection method, various tests were performed in order to see if the cluster algorithm worked as expected in different situations. A simple test is shown on an image with two people together, who share the same blob, as shown in FIG. 21. It is observable that the algorithm is able to cluster these two people separated, but not as well as it should be. Another simple test is shown on an image where a person is riding a bike, as shown in FIG. 22. In this case the human detection method clusters the same person as if there were two together. Finally, the last test for human detection was observed when the algorithm for human counting gives less people that actual people in the scene, as shown in FIG. 23. In this case the k-means algorithm will try to cluster all the pixels even if they are far, making the green rectangle very big to connects all the pixels. This also happens when there are noisy pixels in the scene that were not removed in the Background Subtraction process.

All of these problems can be addressed improving the Background Subtraction process by removing small blobs, and also incrementing the number of clusters passed to the k-means algorithm, but this will lead, sometimes, to more than one rectangle per person.

Shadows were a big problem at the moment of processing sunny day videos. In order to solve this problem, the threshold for the shadow for every video can be studied. After that, the algorithm can be trained to detect when there is more or less sun light in the scene and it can adapt automatically this threshold for real time videos.

Every pixel in this algorithm counts for both the creation of the codebook and its loading, and also to detect the people in the scene. Objects such as small birds, small movements of trees and small changes in image illumination can lead the algorithm to behave incorrectly in some cases. For that reason, those small objects in the image can be filtered and removed from the foreground mask prior to beginning of the human counting and human detection process.

When the video has a low quality (small bitrate and resolution) the performance of the algorithm may drop. To solve this problem the image can smoothed before starting the Background Subtraction process. For example, using a Gaussian filter in which each point in the input array is convolved with a Gaussian kernel and then summing to produce the output array.

The position of the camera can also have a high impact in the performance of the algorithm. Cameras that are not high enough can be problematic since people from the bottom of the image will be much bigger than those at the top. This problem can be addressed by segmenting the image and giving different values to the pixels in those parts and removing the bottom part, although a higher camera would solve this problem. Also, some of these cameras move to point different views and the foreground mask gives wrong pixels. The system solves this problem by detecting those movements and restarts the MoG algorithm.

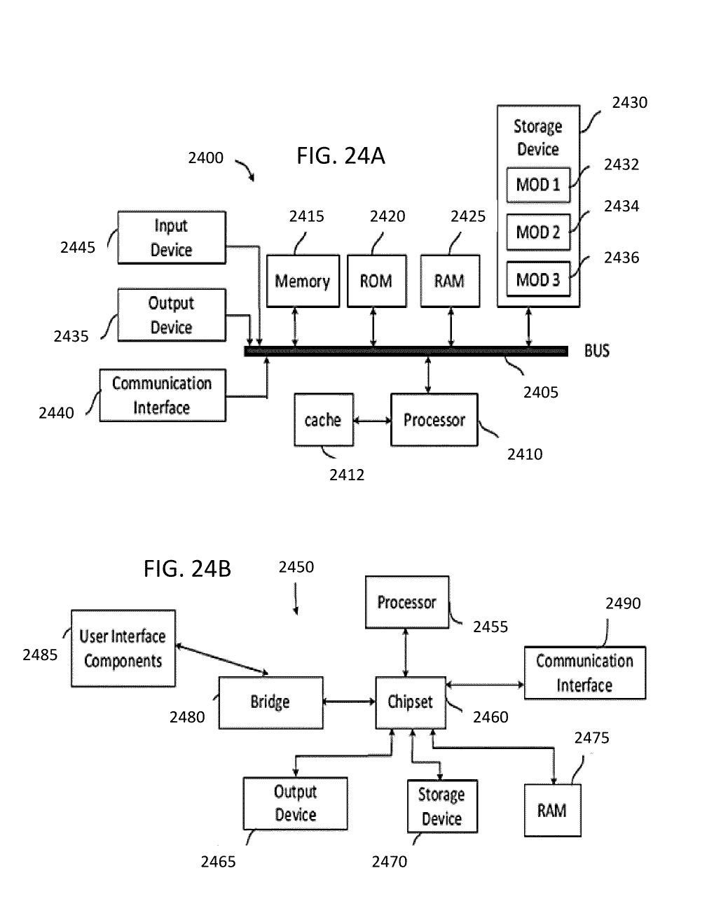

FIG. 24A illustrates a conventional system bus computing system architecture 2400 wherein the components of the system are in electrical communication with each other using a bus 2405. Exemplary system 2400 includes a processing unit (CPU or processor) 2410 and a system bus 2405 that couples various system components including the system memory 2415, such as read only memory (ROM) 2420 and random access memory (RAM) 2425, to the processor 2410. The system 2400 can include a cache of high-speed memory connected directly with, in close proximity to, or integrated as part of the processor 2410. The system 2400 can copy data from the memory 2415 and/or the storage device 2430 to the cache 2412 for quick access by the processor 2410. In this way, the cache can provide a performance boost that avoids processor 2410 delays while waiting for data. These and other modules can control or be configured to control the processor 2410 to perform various actions. Other system memory 2415 may be available for use as well. The memory 2415 can include multiple different types of memory with different performance characteristics. The processor 2410 can include any general purpose processor and a hardware module or software module, such as module 1 2432, module 2 2434, and module 3 2436 stored in storage device 2430, configured to control the processor 2410 as well as a special-purpose processor where software instructions are incorporated into the actual processor design. The processor 2410 may essentially be a completely self-contained computing system, containing multiple cores or processors, a bus, memory controller, cache, etc. A multi-core processor may be symmetric or asymmetric.

To enable user interaction with the computing device 2400, an input device 2445 can represent any number of input mechanisms, such as a microphone for speech, a touch-sensitive screen for gesture or graphical input, keyboard, mouse, motion input, speech and so forth. An output device 2435 can also be one or more of a number of output mechanisms known to those of skill in the art. In some instances, multimodal systems can enable a user to provide multiple types of input to communicate with the computing device 2400. The communications interface 2440 can generally govern and manage the user input and system output. There is no restriction on operating on any particular hardware arrangement and therefore the basic features here may easily be substituted for improved hardware or firmware arrangements as they are developed.

Storage device 2430 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 2425, read only memory (ROM) 2420, and hybrids thereof.

The storage device 2430 can include software modules 2432, 2434, 2436 for controlling the processor 2410. Other hardware or software modules are contemplated. The storage device 2430 can be connected to the system bus 2405. In one aspect, a hardware module that performs a particular function can include the software component stored in a computer-readable medium in connection with the necessary hardware components, such as the processor 2410, bus 2405, display 2435, and so forth, to carry out the function.

FIG. 24B illustrates a computer system 2450 having a chipset architecture that can be used in executing the described method and generating and displaying a graphical user interface (GUI). Computer system 2450 is an example of computer hardware, software, and firmware that can be used to implement the disclosed technology. System 2450 can include a processor 2455, representative of any number of physically and/or logically distinct resources capable of executing software, firmware, and hardware configured to perform identified computations. Processor 2455 can communicate with a chipset 2460 that can control input to and output from processor 2455. In this example, chipset 2460 outputs information to output 2465, such as a display, and can read and write information to storage device 2470, which can include magnetic media, and solid state media, for example. Chipset 2460 can also read data from and write data to RAM 2475. A bridge 2480 for interfacing with a variety of user interface components 2485 can be provided for interfacing with chipset 2460. Such user interface components 2485 can include a keyboard, a microphone, touch detection and processing circuitry, a pointing device, such as a mouse, and so on. In general, inputs to system 2450 can come from any of a variety of sources, machine generated and/or human generated.

Chipset 2460 can also interface with one or more communication interfaces 2490 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 2455 analyzing data stored in storage 2470 or 2475. Further, the machine can receive inputs from a user via user interface components 2485 and execute appropriate functions, such as browsing functions by interpreting these inputs using processor 2455.

It can be appreciated that exemplary systems 2400 and 2450 can have more than one processor 2410 or be part of a group or cluster of computing devices networked together to provide greater processing capability.

For clarity of explanation, in some instances the present technology may be presented as including individual functional blocks including functional blocks including devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims. Claim language reciting “at least one of” a set indicates that one member of the set or multiple members of the set satisfy the claim. Tangible computer-readable storage media, computer-readable storage devices, or computer-readable memory devices, expressly exclude media such as transitory waves, energy, carrier signals, electromagnetic waves, and signals per se.

While various embodiments of the present invention have been described above, it should be understood that they have been presented by way of example only, and not limitation. Numerous changes to the disclosed embodiments can be made in accordance with the disclosure herein without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

The terminology used herein is for the purpose of describing particular embodiments only and is not intended to be limiting of the invention. As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

What is claimed is:

1. A method, comprising:
obtaining image data for multiple sequential images of a physical area acquired by a camera;
based on the image data, generating a background mask for at least one image from the multiple images, the background mask indicating pixels from the image data for the at least one image identified as corresponding to non-moving regions in the at least one image and pixels in the at least one image identified as corresponding to moving regions in the at least one image meeting an exclusion criteria;
based on the background mask, generating a foreground mask for the at least one image identifying pixels in the image associated with persons; and
computing an estimate of a number of persons in the physical area based at least on the number of the foreground pixels and pre-defined relationship between a number of pixels and a number of persons for the camera.

2. The method of claim 1, further comprising:
determining locations of persons in the physical area based on the foreground pixels.

3. The method of claim 2, wherein the determining comprises:
extracting feature points in the at least one image based on the foreground mask; and
identifying the locations of person in the physical area based on a clustering of the feature points in the at least one image.

4. The method of claim 1, wherein the exclusion criteria comprises at least one of a moving shadow removal criteria, a moving vegetation removal criteria, or a moving vehicle removal criteria.

5. The method of claim 1, wherein the computing of the estimate comprises compensating for a perspective distortion of the at least one image by dividing the at least one image into a plurality of frames, computing a number of the foreground pixels in each of the plurality of frames and summing together the number of the foreground pixels in each of the plurality of frames, weighted by a constant for a corresponding one of the plurality of frames.

6. The method of claim 1, further comprising performing the generating and the computing on a select portion of the at least one image.

7. A computer-readable medium, having stored thereon a computer program executable by computing device, the computer program comprising a plurality of instruction for causing the computing device to perform operations comprising:
obtaining image data for multiple sequential images of a physical area acquired by a camera;
based on the image data, generating a background mask for at least one image from the multiple images, the background mask indicating pixels from the image data for the at least one image identified as corresponding to non-moving regions in the at least one image and pixels in the at least one image identified as corresponding to moving regions in the at least one image meeting an exclusion criteria;
based on the background mask, generating a foreground mask for the at least one image identifying pixels in the image associated with persons; and
computing an estimate of a number of persons in the physical area based at least on the number of the foreground pixels and pre-defined relationship between a number of pixels and a number of persons for the camera.

8. The computer-readable medium of claim 7, further comprising:
determining locations of persons in the physical area based on the foreground pixels.

9. The computer-readable medium of claim 8, wherein the identifying comprises:
extracting feature points in the at least one image based on the foreground mask; and
identifying the locations of person in the physical area based on a clustering of the feature points in the at least one image.

10. The computer-readable medium of 7, wherein the exclusion criteria comprises at least one of a moving shadow removal criteria, a moving vegetation removal criteria, or a moving vehicle removal criteria.

11. The computer-readable medium of 7, wherein the computing of the estimate comprises compensating for a perspective distortion of the at least one image by dividing the at least one image into a plurality of frames, computing a number of the foreground pixels in each of the plurality of frames and summing together the number of the foreground pixels in each of the plurality of frames, weighted by a constant for a corresponding one of the plurality of frames.

12. The computer-readable medium of 7, further comprising performing the generating and the computing on a select portion of the at least one image.

13. A system, comprising:
a processor;
a computer readable medium having stored thereon a plurality of instructions for causing the processor to perform operations comprising:
obtaining image data for multiple sequential images of a physical area acquired by a camera;
based on the image data, generating a background mask for at least one image from the multiple images, the background mask indicating pixels from the image data for the at least one image identified as corresponding to non-moving regions in the at least one image and pixels in the at least one image identified as corresponding to moving regions in the at least one image meeting an exclusion criteria;
based on the background mask, generating a foreground mask for the at least one image identifying pixels in the image associated with persons; and
computing an estimate of a number of persons in the physical area based at least on the number of the foreground pixels and pre-defined relationship between a number of pixels and a number of persons for the camera.

14. The system of claim 13, the computer readable medium further comprising additional instructions for causing to the processor to determining locations of persons in the physical area based on the foreground pixels.

15. The system of claim 14, wherein the determining comprises:
extracting feature points in the at least one image based on the foreground mask; and
identifying the locations of person in the physical area based on a clustering of the feature points in the at least one image.

16. The system of claim 13, wherein the exclusion criteria comprises at least one of a moving shadow removal criteria, a moving vegetation removal criteria, or a moving vehicle removal criteria.

17. The system of claim 13, wherein the computing of the estimate comprises compensating for a perspective distortion of the at least one image by dividing the at least one image into a plurality of frames, computing a number of the foreground pixels in each of the plurality of frames and summing together the number of the foreground pixels in each of the plurality of frames, weighted by a constant for a corresponding one of the plurality of frames.

18. The system of claim 13, further comprising performing the generating and the computing on a select portion of the at least one image.
